(19) United States
(12) Patent Application Publication
(10) Pub. No.: US 2014/0341545 A1
(43) Pub. Date: Nov. 20, 2014

(54) SYSTEMS AND METHODS FOR VIDEO PLAYBACK CONTROL

(71) Applicant: GM Global Technology Operations LLC, Detroit, MI (US)

(72) Inventors: David R. Petrucci, Warren, MI (US); Douglas C. Martin, Warren, MI (US); Charles A. Massoll, Warren, MI (US); Mark P. Friedrich, Warren, MI (US); Charlene A. Goike, Warren, MI (US)

(73) Assignee: GM Global Technology Operations LLC, Detroit, MI (US)

(21) Appl. No.: 13/896,212

(22) Filed: May 16, 2013

(51) Int. Cl. G11B 27/10; H04N 9/87

(52) U.S. Cl. CPC G11B 27/10; H04N 9/87
USPC 386/262

(57) ABSTRACT

Methods and apparatus are provided for a video playback control system for a vehicle. The method can include receiving a source of video data and accessing a data store for a run script associated with the playback of the video data. The method can also include if no run script exists in the data store, generating a log of user input received for the playback of the video data. The method can include storing the log in the data store as a run script associated with the playback of the video data.

### TECHNICAL FIELD

The present disclosure generally relates to vehicles and more particularly relates to systems and methods for video playback control in a vehicle.

### BACKGROUND

Many vehicles employ rear seat entertainment devices, for example, devices that allow for video playback in a rear cabin of the vehicle. Generally, the rear seat entertainment devices can be used to entertain younger passengers, who are unable to operate or control the video playback on the rear seat entertainment device. Thus, in many instances, a driver of the vehicle needs to be able to control the playback on the rear seat entertainment device.

Accordingly, it is desirable to provide systems and methods that enable a driver of a motor vehicle to easily control the video playback on a rear seat entertainment device. Furthermore, other desirable features and characteristics of the present disclosure will become apparent from the subsequent detailed description and the appended claims, taken in conjunction with the accompanying drawings and the foregoing technical field and background.

### SUMMARY

A method is provided for controlling video playback in a cabin of a vehicle. The method includes receiving a source of video data and accessing a data store for a run script associated with the playback of the video data. The method also includes if no run script exists in the data store, generating a log of user input received for the playback of the video data. The method includes storing the log in the data store as a run script associated with the playback of the video data.

An apparatus is provided for a video playback control system for a vehicle. The apparatus includes at least one user input device that receives a user input, and at least one display located in a rear cabin of the vehicle. The apparatus also includes a source of video data for display on the at least one display. The apparatus includes a control module that accesses a data store for a run script for playback of the video data based on a unique identifier associated with the source of video data and substantially automatically outputs the video data to the at least one display based on the run script.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle that includes a video control system in accordance with various embodiments;

FIG. 2 is a dataflow diagram illustrating a video playback control system of the video control system in accordance with various embodiments;

FIG. 3 is a flowchart illustrating a control method of the video control system in accordance with various embodiments; and

FIG. 4 is a continuation of the flowchart of FIG. 3.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

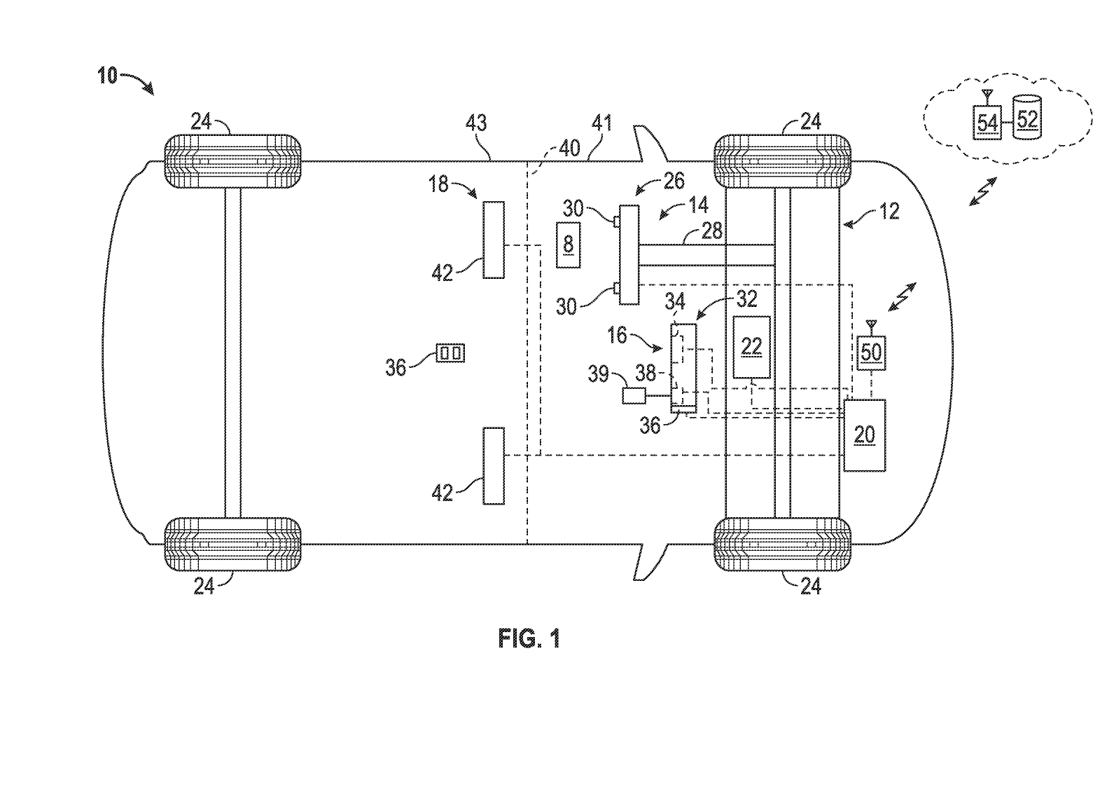

With reference to FIG. 1, a vehicle 10 is shown. The vehicle 10 includes a powertrain 12, a steering system 14, a video control system 16, a rear entertainment system 18 and a control module 20. As will be discussed in greater detail herein, the control module 20 receives inputs from the video control system 16 to control the operation of the rear entertainment system 18.

Generally, the vehicle 10 can include the powertrain 12 for propulsion. The powertrain 12 can include, for example, a propulsion device, including, but not limited to, an internal combustion engine, electric engine or hybrid thereof (not shown). The propulsion device can supply power to a transmission, which can transfer this power to a suitable driveline coupled to one or more wheels (and tires) 24 of the vehicle 10 to enable the vehicle 10 to move.

With continued reference to FIG. 1, the steering system 14 can include a hand wheel 26 coupled to a steering shaft 28, which can cooperate with the powertrain 12 to steer the vehicle 10. In this example, the hand wheel 26 can include one or more user input devices 30, which can provide an input to the control module 20. The powertrain 12 and steering system 14 are shown only in block form and without further detailed description, as embodiments of these mechanisms are varied and well known to those skilled in the art.

The video control system 16 can include a first display or display 32 and a video player 34. The display 32 can be in communication with the control module 20 and can provide visual information to the driver 8 and/or other users of the vehicle 10. In one example, the display 32 can be implemented as a flat panel display in an instrument panel or console of the vehicle 10. Those skilled in the art realize other techniques to implement the display 32 in the vehicle 10. The display 32 can comprise any suitable technology for displaying information, including, but not limited to, a liquid crystal display (LCD), organic light emitting diode (OLED), plasma, or a cathode ray tube (CRT). The video control system 16 can also include one or more user input devices 36. In one example, the user input device 36 can be implemented with the display 32, and can receive inputs from a user, such as the driver 8 of the vehicle 10 or from other occupants in the vehicle 10, to control the rear entertainment system 18. Alternatively, or in addition to, the user input device 36 may be implemented as a keyboard (not separately shown), a remote control, a microphone (not separately shown), a touchscreen layer associated with the display 32, or other suitable device to receive data and/or commands from the user, which can be communicated to the control module 20. Of course, multiple input devices 36 can also be utilized.

The video control system 16 can also include one or more input ports 38, including, but not limited to, a USB port, SD port, HDMI port, which can enable a portable electronic device 39 to be coupled to the video control system 16. For example, the portable electronic device 39 can include, but is not limited to, a tablet personal computing device, cellular phone, portable DVD™ player, portable BLU-RAY DISC™ player and/or mobile gaming station, which can be coupled to the video control system 16 to provide a source of video data. It should be noted that although the one or more input ports 38 are illustrated herein as being associated with the display 32, the input ports 38 could be located at any desired location within the vehicle 10, including, but not limited to, the display 32, a console associated with a front cabin 41 of the vehicle 10 or a console associated with a rear cabin 43 of the vehicle 10.

The video player 34 can receive as input a source of video data. In one exemplary embodiment, the video player 34 can be implemented with the display 32, however, the video player 34 could be implemented as a separate device, which could be located at any desirable location within the vehicle 10. The video player 34 can comprise any suitable device that can recognize and output the video data to the control module 20, including, but not limited to, a DVD™ reader, a BLU-RAY DISC™ reader, an MPEG video reader and combinations thereof. Similarly, the source of video data received through the video player 34 can include, but is not limited to, a DVD™ disc, a BLU-RAY DISC™, an MPEG video source, a web-based source of streaming video data and a source of video data available from other modules associated with the vehicle 10. It should be noted that although a single video player 34 is illustrated herein, the vehicle 10 can include any number of video players 34.

The rear entertainment system 18 can be located behind or rearward of the driver 8 of the vehicle 10. In other words, the rear entertainment system 18 can include any entertainment system that is not easily assessable or viewable by the driver 8. In one example, a line 40 can separate the vehicle 10 into the front cabin 41 and the rear cabin 43. Generally, the driver 8 of the vehicle 10 can be seated within seats located in the front cabin 41 and one or more passengers can be seated within seats located in the rear cabin 43. The rear entertainment system 18 can be located within the rear cabin 43 and viewable by those seated with the rear cabin 43. In one example, the rear entertainment system 18 can include at least one second display or one or more displays 42. The displays 42 can be in communication with the control module 20 to receive video data for display on the displays 42. It should be noted that displays 42 can be located at any desired position within the rear cabin 43, including, but not limited to, a headrest of a seat located within the front cabin 41, a console coupled to a headliner of the vehicle 10 in the rear cabin 43 or a console located on a floor of the rear cabin 43. In one example, the displays 42 can receive the same video output from the control module 20, however, it should be noted that the control module 20 could output different video data to each of the displays 42, in the case where each display 42 has a dedicated video player 34. The displays 42 can comprise any suitable technology for displaying information, including, but not limited to, a liquid crystal display (LCD), organic light emitting diode (OLED), plasma, or a cathode ray tube (CRT).

The control module 20 controls the rear entertainment system 18 based on the video data received from the video player 34 and/or one or more input ports 38, and input received from the user input devices 30, 36. It should be noted that the control module 20 can be in communication with the display 32, displays 42, video player 34, one or more input ports 38 and user input devices 30, 36 over a communication bus, such as a data bus, associated with the vehicle 10. In one example, the control module 20 controls the output of or the playback of the video data on the displays 42 based on the identification of the source of the video data and prior interactions with the source of the video data learned from inputs to the user input devices 30, 36. The control module 20 also learns the interactions with the source of the video data and stores these interactions for later use in the vehicle 10 and for use by other vehicles. In addition, the control module 20 controls the output or playback of the video data on the displays 42 based on the identification of the source of the video data from interactions with the video data received from users remote to the vehicle 10.

In this regard, the control module 20 can be in communication with a communications device 50 over the communication architecture, which can enable the transmission and reception of data from a remote source, such as a remote data store 52. The communications device 50 can include, but is not limited to, an antenna, wireless network, mobile network, etc. The data communicated over the communication device 50 may or may not be encrypted. The remote data store 52 stores data associated with various video sources, which can be populated by the control module 20 of the vehicle 10 or from control modules associated with other vehicles.

In one example, the remote data store 52 can store a title of a video source and an interaction log or script that enables the video source to play substantially automatically. For example, the remote data store 52 can store a title of a video source, and a routine of user input necessary for a main feature of the video source to play. As a further example, the remote data store 52 can store the title of the movie, and the number of inputs needed through a respective user input device for the movie to play. Thus, the remote data store 52 enables scripts or user interaction logs associated with a particular video source learned or created in one vehicle to be applied to the same video source being used in another, remote vehicle. In addition, the remote data store 52 can accumulate multiple scripts or user interaction logs associated with particular video sources and apply data processing methods to the multiple scripts or user interaction logs to reject scripts or user interaction logs that are not similar to the majority of learned scripts or user interaction logs. The remote data store 52 can include a suitable communications device 54 to enable communication between the communications device 50 of the vehicle 10 and the remote data store 52. The communications device 54 can comprise any suitable device that cooperates with the communication device 50, including, but not limited to, an antenna, wireless network, mobile network, etc.

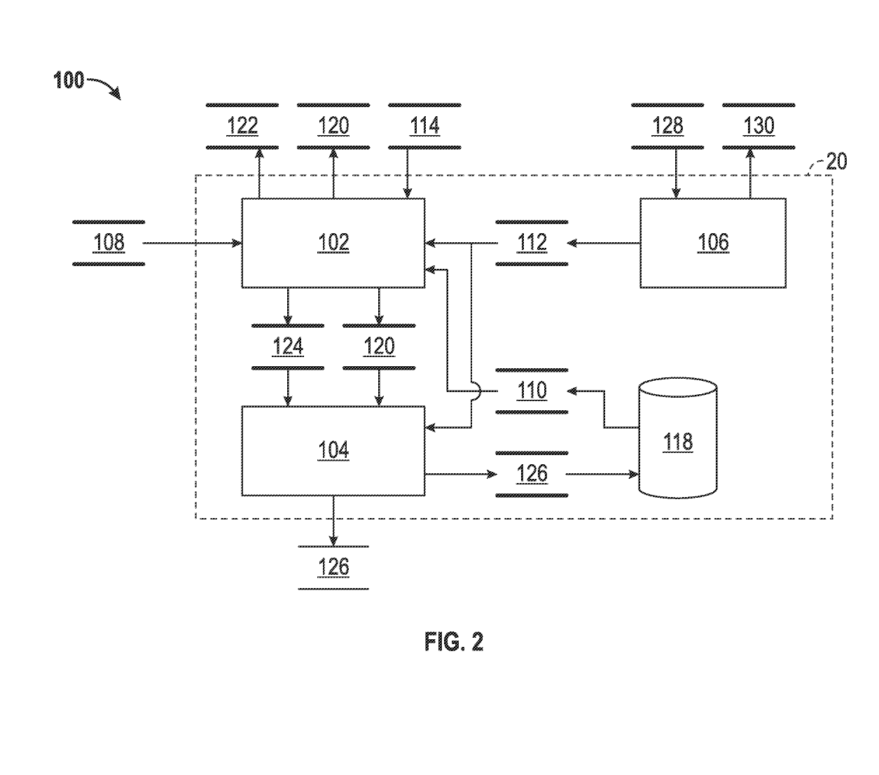

Referring now to FIG. 2, a dataflow diagram illustrates various embodiments of a video playback control system 100 for the rear entertainment system 18 (FIG. 1) that may be embedded within the control module 20. Various embodiments of the video playback control system 100 according to the present disclosure can include any number of sub-modules embedded within the control module 20. As can be appreciated, the sub-modules shown in FIG. 2 can be combined and/or further partitioned to similarly control the video playback for the rear entertainment system 18 (FIG. 1). Inputs to the system may be sensed from the vehicle 10 (FIG. 1), received from other control modules (not shown), and/or determined/modeled by other sub-modules (not shown) within the control module 20. In various embodiments, the control module 20 includes a playback control module 102, a learning module 104 and a user interface (UI) control module 106.

The playback control module 102 receives as input source video data 108, local video run script data 110, user selection data 112 and remote video run script data 114. The source video data 108 can include video data from a video source received by the video player 34 or video data provided by a video source coupled to the input ports 38, which can include content descriptors associated with the video data, including, but not limited to, title, chapter, track, segment, volume, etc. The local video run script data 110 can comprise data retrieved from a local data store 118, which can comprise a script or sequence of user inputs required to launch or play the video data associated with a specific video source. For example, in the case of a movie provided via a DVD™ disc, the local video run script data 110 can comprise a series of user inputs through the user input devices 30, 36, to be executed at a point in time from the insertion of the DVD™ disc into the video player 34, to enable the movie to play, as will be discussed in greater detail below.

The user selection data 112 is received from the UI control module 106, and can comprise user input received from the user input devices 30, 36. In one example, the user selection data 112 can include, but is not limited to, a request to advance the video, play the video, stop the video playback, pause the video playback, return to a video playback menu and play a selected content descriptor of the video, for example, to play a particular chapter and/or title associated with the video. The user selection data 112 can also include an x, y coordinate location if the user input is received to the user input device 36 and/or a specific button depressed if selected through the user input device 30, for example. The remote video run script data 114 can comprise data retrieved from the remote data store 52, which can comprise a script or sequence of user inputs required to launch or play the video data associated with a specific video source.

Based on the source video data 108, the playback control module 102 determines a unique identifier for the source of video data. For example, in the case of a DVD™ disc or a BLU-RAY DISC™, the unique identifier can comprise a title of the video data stored on the DVD™ disc or BLU-RAY DISC™. The unique identifier can be embedded in the source video data 108 provided by the source of video data, or can be determined based on the content descriptors embedded within the source video data 108. For example, the unique time and number of chapters associated with a video can provide a unique identifier for the source of video data. Once the unique identifier is determined, the playback control module 102 sets the unique identifier as video source identifier data 120. Based on the video source identifier data 120, the playback control module 102 can query the local data store 118 for the local video run script data 110 associated with the video source identifier data 120. If local video run script data 110 is available for the video source identified in the video source identifier data 120, the playback control module 102 can retrieve the local video run script data 110 from the local data store 118 and execute the script stored in the local video run script data 110 to output video data 122.

Based on the video source identifier data 120, the playback control module 102 queries the remote data store 52 to determine if remote video run script data 114 associated with the video source identifier data 120 is available within the remote data store 52. If the remote video run script data 114 is available for the video source identifier data 120, then the playback control module 102 can output the video data 122 based on the remote video run script data 114. The playback control module 102 can also set the video source identifier data 120 for the learning module 104, and can set content descriptor data 124 for the learning module 104. The content descriptor data 124 can comprise content descriptors associated with the video data, including, but not limited to, title, chapter, track, segment, volume, etc.

The learning module 104 receives as input the video source identifier data 120, the content descriptor data 124 and the user selection data 112. The learning module 104 generates video source log data 126 based on the video source identifier data 120, the content descriptor data 124 and the user selection data 112. In this regard, for a particular video source identifier data 120, the learning module 104 generates video source log data 126 that comprises a particular user input received as user selection data 112 at a particular point in the video data based on the content descriptor data 124 and the time elapsed since the source of video data has been received by the video player 34 or input ports 38. In other words, the learning module 104 learns or records the user input received via the user input devices 30, 36 at one or more predefined points in the video data for a particular video source, and create the video source log data 126, which can be stored in the local data store 118 and retrieved by the playback control module 102 as local video run script data 110. The learning module 104 also outputs the video source log data 126 to the remote data store 52. The video source log data 126 enables the same steps to be performed by the control module 20 the next time the video source is activated (e.g. the DVD™ disc or BLU-RAY DISC™ is inserted into the video player 34) without user interaction.

The UI control module 106 receives as input user input data 128. The user input data 128 can comprise user input received via the user input devices 30, 36. The user input data 128 can comprise a request to control the operation of the video playback on the rear entertainment system 18. Based on the user input data 128, the UI control module 106 accesses a look-up table or a calibration table and set the user selection data 112 for the playback control module 102 and learning module 104. The UI control module 106 also outputs a user interface 130. The user interface 130 can comprise any suitable graphical or textual interface that can cooperate with the user input devices 30, 36 to enable the user to control the operation of the rear entertainment system 18. For example, the user interface 130 could comprise one or more graphical and/or textual indicators that the user can select to advance, pause, play, stop and/or select a particular content descriptor of the video to view. The user interface 130 can also include a single frame of the video data, if desired, and can include a selector to enable the user to flag an error with the run script through the user input devices 30, 36. It should be noted that these user interface 130 features are merely exemplary, as the user interface 130 could include any suitable graphical and/or textual indicators to enable control of video playback. Further, the user interface 130 can be superimposed on at least a portion of the video data, if desired.

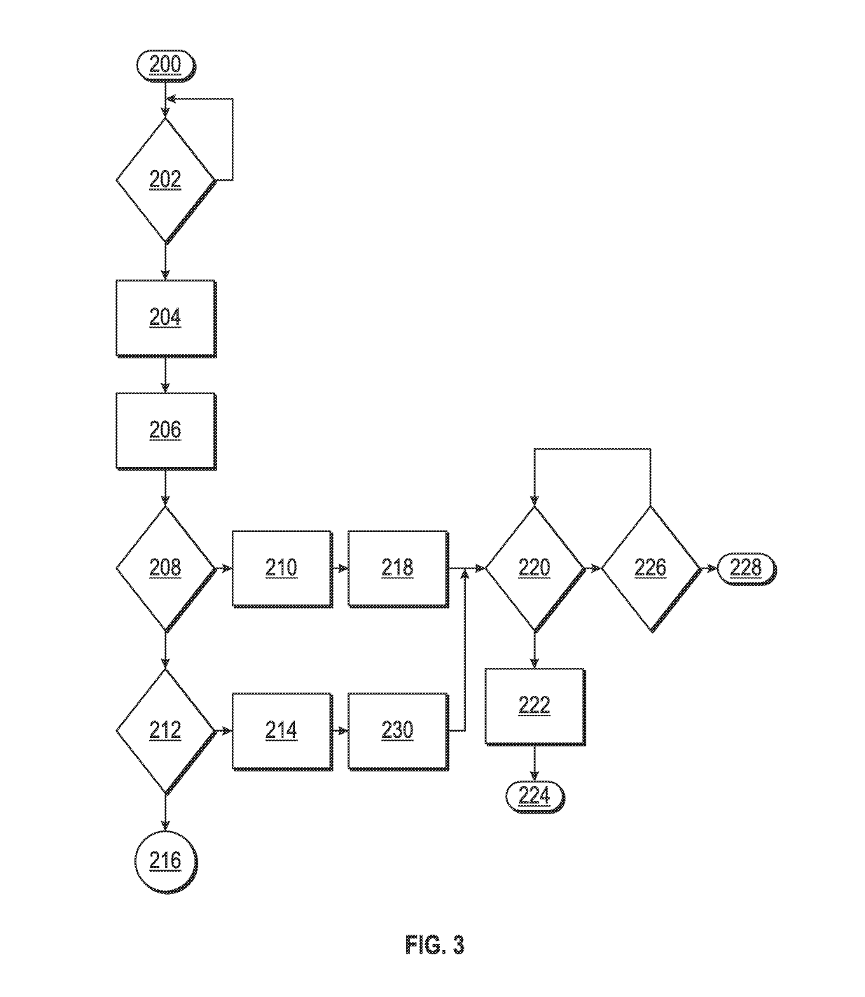

Referring now to FIG. 3, and with continued reference to FIGS. 1 and 2, a flowchart illustrates a control method that can be performed by the control module 20 of FIG. 1 in accordance with the present disclosure. As can be appreciated in light of the disclosure, the order of operation within the method is not limited to the sequential execution as illustrated in FIG. 3, but may be performed in one or more varying orders as applicable and in accordance with the present disclosure.

In various embodiments, the method can be scheduled to run based on predetermined events, and/or can run continually during operation of the vehicle 10.

The method begins at 200. At 202, the method determines if a source of video data or source video data 108 is available to the control module 20. For example, the method determines if a DVD™ disc or a BLU-RAY DISC™ has been inserted into the video player 34, or if a source of video data has been coupled to the input ports 38. If source video data 108 is available to the control module 20, then the method goes to 204. Otherwise, the method loops.

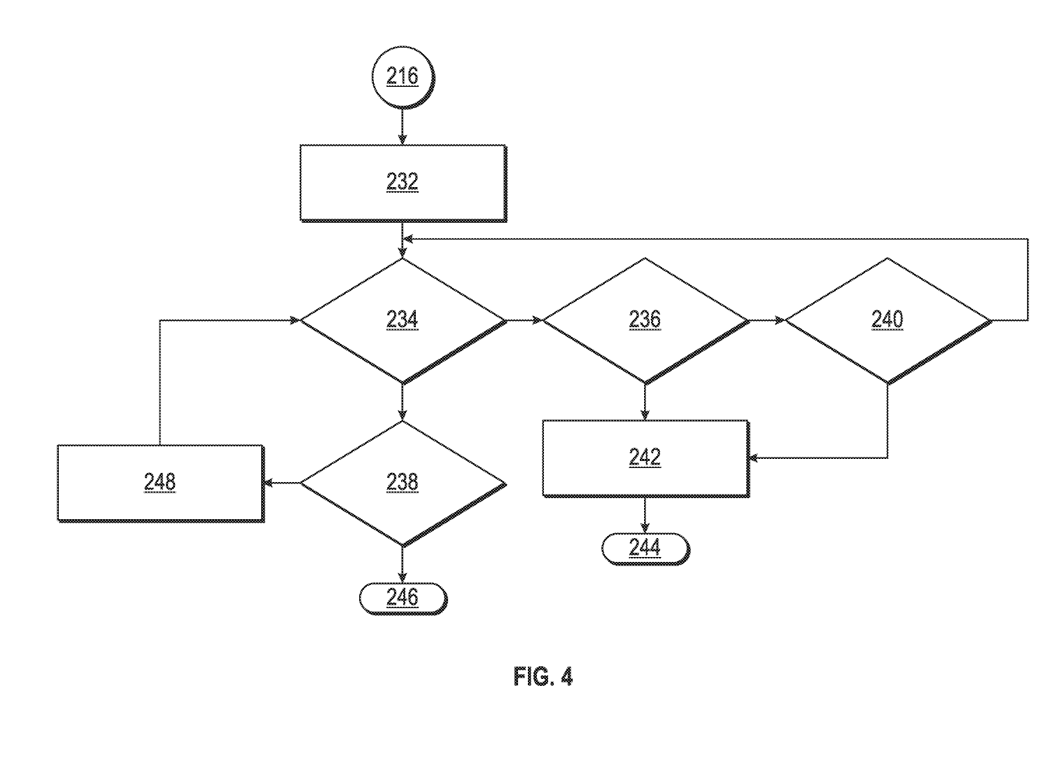

At 204, the method sets a timer equal to zero. At 206, the method determines the video source identifier data 120 from the source video data 108. At 208, the method queries the local data store 118 and determine if local video run script data 110 is available for video source identifier data 120. If the local video run script data 110 is available, then the method goes to 210. Otherwise, at 212, the method queries the remote data store 52 and determines if remote video run script data 114 is available for the video source identifier data 120. If remote video run script data 114 is available, the method goes to 214. Otherwise, the method goes to 216 on FIG. 4.

At 210, the method retrieves the local video run script data 110 from the local data store 118. Then, at 218, the method outputs the video data 122 based on the local video run script data 110. At 220, the method determines if a user input has been received from the user input devices 30, 36. If a user input has been received, the method flags an error at 222. In this regard, the receipt of user input can indicate that there is an error with the run script for the identified source of video data. In this way, a script that has undesirable actions can be disabled or removed from the local data store 118, which will allow new video source log data 126 to be stored or recorded. In one example, the error can be sent to the local data store 118 to enable the detection of an incorrect run script or the detection of more than one version of a video source such that two different run scripts exist for the same or similar video source. Then, the method ends at 224.

Otherwise, if no user input has been received, the method at 226 determines if the run script is complete such that the video data 122 being output is the main feature. If the run script is complete, then the method ends at 228. Otherwise, the method loops.

At 214, the method retrieves the remote video run script data 114 from the remote data store 52. At 230, the method outputs the video data 122 based on the remote video run script data 114. Then, the method goes to 220.

With reference now to FIG. 4, from 216 the method goes to 232. At 232, the method stores the video source identifier data 120 in the local data store 118. Then, at 234, the method determines if a user input has been received through the user input devices 30, 36. If user input has not been received, the method goes to 236. Otherwise, the method goes to 238.

At 236, the method determines if the timer is greater than a threshold time, such as about 5 minutes. If the timer is less than the threshold, then the method goes to 240. Otherwise, the method goes to 242.

At 240, the method determines, based on the content descriptor data 124 if the video data 122 output is the main feature or main presentation. In other words, in the example of a DVD™ disc or a BLU-RAY DISC™ inserted into the video player 34, the method determines if the main feature or main presentation of the movie on the DVD™ disc or BLU-RAY DISC™ is being output as video data 122. If the main feature comprises the video data 122, then the method goes to 242. Otherwise, the method loops. At 242, the method outputs the video source log data 126 for the remote data store 52. Then, the method ends at 244.

At 238, the method determines if the user input comprises user selection data 112 associated with a request to reverse the video data 122. If the user selection data 112 comprises a reverse request, the method ends at 246. Otherwise, at 248, the method stores the current time of the timer, the user selection data 112 and content descriptor data 124 associated with the current time in the local data store 118. Then, the method loops to 234.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A method of controlling video playback in a cabin of a vehicle, comprising:
receiving a source of video data;
accessing a data store for a run script associated with the playback of the video data;
if no run script exists in the data store, generating a log of user input received for the playback of the video data; and
storing the log in the data store as a run script associated with the playback of the video data.

2. The method of claim 1, wherein accessing the data store for the run script further comprises:
accessing a local data store on the vehicle.

3. The method of claim 1, wherein accessing the data store for the run script further comprises:
accessing a remote data store.

4. The method of claim 1, wherein generating the log of user input received for the playback of the video data further comprises:
determining if a user input has been received from at least one user input device;
if a user input has been received, determining a characteristic associated with the video data when the user input was received; and
storing the user input and the characteristic in the data store.

5. The method of claim 4, wherein determining a characteristic associated with the video data further comprises:
determining a content identifier associated with the video data.

6. The method of claim 4, wherein the source of video data is received at an initial time, and determining a characteristic associated with the video data further comprises:
determining a time that has elapsed between the initial time when the source of video data was received and the user input.

7. The method of claim 1, further comprising:
outputting video data to at least one display located within the cabin of the vehicle based on the run script.

8. The method of claim 1, further comprising:
determining a unique identifier associated with the source of video data; and
accessing the data store to retrieve the run script based on the unique identifier.

9. A video playback control system for a vehicle, comprising:
at least one user input device that receives a user input;
at least one display located in a rear cabin of the vehicle;
a source of video data for display on the at least one display; and
a control module that accesses a data store for a run script for playback of the video data based on a unique identifier associated with the source of video data and substantially automatically outputs the video data to the at least one display based on the run script.

10. The system of claim 9, wherein if the data store does not include the run script for the playback of the video data, the control module generates a log for the playback of the video data based on input to the at least one user input device.

11. The system of claim 10, wherein the log includes the input to the at least one user input device associated with at least one content descriptor of the video data.

12. The system of claim 10, wherein the source of video data is provided at an initial time, and the log includes the input to the at least one user input device associated with a time measured from the initial time.

13. The system of claim 9, wherein the control module accesses a data store located on the vehicle.

14. The system of claim 9, wherein the control module accesses a data store remote from the vehicle.

15. A vehicle, comprising:
a passenger cabin;
at least one display located within the passenger cabin;
at least one user input device located within the passenger cabin that receives user input;
a source of video data for display on the at least one display;
a control module that controls the display of the video data on the at least one display, and the control module:
determines a unique identifier associated with the source of video data;
based on the unique identifier, accesses a local data store for a run script for playback of the video data;
if no run script is associated with the unique identifier, generates a log of user input received by the at least one user input device during the playback of the video data; and
stores the log in the local data store as the run script for the playback of the video data.

16. The vehicle of claim 15, further comprising:
a video player in communication with the control module,
wherein the source of video data is received as input to the video player.

17. The vehicle of claim 15, further comprising:
an input port in communication with the control module,
wherein the source of video data is received from a portable electronic device coupled to the input port.

18. The vehicle of claim 15, wherein the control module accesses a remote data store for a run script for playback of the video data if no run script is associated with the unique identifier in the local data store.

19. The vehicle of claim 18, wherein the control module outputs the log to the remote data store.

20. The vehicle of claim 15, wherein the source of video data is provided at an initial time, and the log includes the user input associated with a time measured from the initial time.
